(19) United States
(12) Patent Application Publication
(10) Pub. No.: US 2008/0041297 A1
(43) Pub. Date: Feb. 21, 2008

(54) METHOD AND APPARATUS FOR AN AUTOMOBILE THAT ALERTS OTHERS TO UNSAFE DRIVING CONDITIONS OR AN AUTOMOBILE ACCIDENT

(76) Inventor: Houshang Vazin, Rancho Palos Verdes, CA (US)

Correspondence Address: Steve Hassid, 1115 1/2 Yale Street, SANTA MONICA, CA, 90403, US

(21) Appl. No.: 11/457,455

(22) Filed: Jul. 13, 2006

(51) Int. Cl. B60Q 9/00

(52) U.S. Cl. 116/32; 340/903

(57) ABSTRACT

The present invention provides for apparatus and related methods for alerting other people that are nearby to the automobile to dangerous driving conditions or accidents comprising. One exemplary embodiment of the present disclosure provides one or more sensors for an automobile that detect dangerous driving conditions or an automobile accident. The sensors communicate with a computer or microprocessor which communicates with one or more devices that release one or mores signals from the automobile to release the one or more signals. Releasing the one or more signals from the automobile alerts those nearby the automobile that there are dangerous driving conditions or an automobile accident allowing them to reduce their speed, change their driving behavior and potentially avoid accidents or significantly reduce the severity of any accident that they encounter. The present invention provides these and other vehicle safety advantages.

### BACKGROUND OF THE INVENTION

1. Field of the Invention

The present invention relates generally to vehicle and driver safety and more particularly to an apparatus and related method for alerting drivers to unsafe driving conditions or an automobile accident.

2. Description of the Related Art

The U.S. Department of Transportation's Nation Highway Traffic Administration (NHTA) estimates that in 2004, traffic accidents took the lives of 42,636 individuals in the United States alone. Similarly, the NHTA estimates that in 2004, 2,788,000 individuals were injured and 4,281,000 individuals suffered property damage due to automobile accidents. Clearly, traffic accidents cost U.S. citizens hundreds of millions of dollars every year and have a tremendous negative impact on our society.

Many technological advances have improved vehicle and crash safety. Examples of those improvements to automobiles include anti-lock (a.k.a., ABS) braking systems, airbags, crumple zones, reinforced automobile bodies and sophisticated handling and traction systems. It should be appreciated that some of these advances, including anti-lock braking systems and handling and traction systems are designed to prevent or reduce the severity of accidents, whereas other advances, including airbags, crumple zones and reinforced automobile bodies are designed to reduce, direct or limit the damage an automobile accident causes to the automobile or its occupants once the accident has occurred.

Automobiles are all equipped with hazard lights. Typically, if a button in the automobile is depressed the rear taillight or lights of the car will flash altering those nearby to a potential problem. Unfortunately, hazard lights are often overused (e.g., when a vehicle is double or illegally parked). As a result, drivers sometimes ignore hazard lights or do not treat them as a sign that there is a potential problem. Additionally, because hazard lights and produce the same alert or signal as one tapping on their brakes at a certain interval and they can only be seen by drivers and pedestrians that have a direct line of sight with the rear tail lights, drivers sometimes don't notice hazard lights until it is too late. Accordingly, a better way of notifying drivers to potentially unsafe environments is desired.

Unfortunately, as the NHTA statistics demonstrate, the technology available on today's automobiles has not progressed enough to prevent the tens of thousands of deaths and millions of injuries that car accidents cause each year. Many of these deaths and injuries could be prevented if the accident itself could be prevented or its severity could be reduced. This and other related benefits can be accomplished is by alerting nearby drivers and pedestrians to unsafe driving conditions or accidents. The present invention provides these and other related advantages.

### SUMMARY OF THE INVENTION

Briefly, and in general terms, by way of example and not limitation, one aspect of the present invention resides in improved apparatus and related methods for alerting others to unsafe driving conditions or an automobile accident.

By way of example and not limitation, in one exemplary embodiment of the present disclosure an apparatus for alerting other people that are nearby to the automobile that dangerous driving conditions or accidents exists is provided.

In one aspect of the present invention the apparatus includes 1) one or more sensors for detecting dangerous driving conditions or an automobile accident, 2) a computer or microprocessor that controls the one or more devices for releasing one or more signals from the automobile or the one or more sensors, 3) one ore more devices for releasing one or mores signals from the automobile that alerts others that are nearby to one or more dangerous driving conditions or accidents, and 4) one ore more signals that are released from the automobile to alert others that are nearby to the automobile to one or more dangerous driving conditions or accidents.

In yet another aspect of the of the present disclosure, the one or more sensors communicate with the computer or microprocessor to indicate that the sensor has been activated or triggered, the computer or microprocessor communicates with the one or more devices for releasing one or more signals from the automobile to release one or more signals from the automobile and the one or more devices for releasing one or more signals releases one or more signals from the automobile alerting others that are nearby to one or more dangerous driving conditions of accidents.

In yet another aspect of the present disclosure, the one or more signals that are released from the automobile to alert those that are nearby to one or more dangerous driving conditions or accidents are released by the device for releasing one or more signals by compressed air or minor explosives, are comprised primarily of an any metal (e.g., aluminum), a fabric, a plastic or a composite material, are reflective to light, include a flashing light or lights, move back and forth relative to the automobile, can be placed back into the device for releasing one or more signals from the automobile, and re-used, are spring loaded, contain symbols or signs indicating one or more unsafe driving conditions or accidents or contain various color or symbols that indicate the level or type of hazardous road condition or accident.

In yet another aspect of the present disclosure, the one or more devices the one ore more signals that are released from the automobile are released from the roof portion of the automobile.

In yet another aspect of the present disclosure, the one or more signals are audio and visual signals that indicate to others that are nearby that they should slow down and be extra cautious because one or more dangerous driving conditions exist or accidents have occurred.

In yet another aspect of the present disclosure, the signals released from the automobile are a visual signal that appears at least one foot, and more preferably up to six feet, above the most elevated portion the automobile to allow others nearby that one or more unsafe driving conditions or accidents have occurred.

In yet another aspect of the present disclosure, the visual signals are provided at least four feet above the top of the automobile.

In yet another aspect of the present disclosure, the signals are released from the automobile after an occupant of the automobile activates or triggers a button or sensor in the automobile.

In yet another embodiment of the present disclosure, a kit for use with a motor vehicle that alerts other people that are nearby to the motor vehicle to dangerous driving conditions or accidents is provided. The kit contains 1) one or more sensors for detecting dangerous driving conditions or an automobile accident, 2) a computer or microprocessor that controls the one or more sensors 3) a device for releasing one or mores signals from the automobile that alert others that are nearby to one or more dangerous driving conditions or accidents; and 4) one ore more signals that are released from the automobile to alert others that are nearby to one or more dangerous driving conditions or accidents. The sensors communicate with the computer or microprocessor to indicate that the sensors have been activated or triggered. The computer or microprocessor communicates with the device for releasing one or more signals from the automobile to release one or more signals from the automobile and the device for releasing one or more signals releases one or more signals from the automobile alerting others that are nearby to one or more dangerous driving conditions or accidents. In yet another aspect of the present invention, the kit can be provided as a portable package that the owner of a vehicle can purchase independently and put in his or her car in case of emergency. The kit can be used if the automobile does not already have the apparatus containing all the components of the kit pre-installed or if the pre-installed kit is damaged and there is still a need to alert those nearby to an accident or an unsafe driving condition. It should be appreciated that the kit also provides the benefit of being transferable from one automobile to the next. It should also be appreciated that the kit can be provided without any sensors because an occupant of the automobile can cause the one or more signals to release without the need for a sensor.

In yet another aspect of the present disclosure, the one ore more signals that are released from the automobile after an occupant of the automobile activates or triggers a button or sensor in the automobile.

In yet another embodiment of the present disclosure, a method for preventing automobile accidents and reducing the severity of those automobile accidents that occur by alerting other people that are nearby to the automobile to dangerous driving conditions and accidents is provided. The method involves 1) providing a sensor on an automobile for detecting one or more dangerous driving conditions or accidents, 2) providing a device on the automobile that releases one ore more visual signals that alert others nearby when one or more dangerous driving conditions or accidents are detected by the sensor, and 3) providing a visual signal that alerts nearby drivers to one or more dangerous driving conditions. The sensor sends a signal to the device that releases one ore more visual signals from the automobile to release the one ore more visual signals when the sensor detects one or more dangerous driving conditions or accidents; and the released visual signal alerts others nearby to one or more dangerous driving conditions or accidents.

In yet another aspect of the present disclosure, providing a sensor on an automobile is performed by providing an automobile occupant that can sense or detect one or more unsafe driving conditions or automobile accidents.

In yet another aspect of the present disclosure, the automobile occupant activates or triggers a button that causes the device on the automobile that releases one or more visual signal to release the one or more visual signals which alerts other people nearby to one or more dangerous driving conditions or accidents.

It should be appreciated that the present is not limited to the exemplary embodiments described in the forgoing summary of the invention and encompasses the modifications and variations known to those skilled in the art. Accordingly, the present invention is defined only by the claims below in light of the detailed description and the drawings provided herewith.

### BRIEF DESCRIPTION OF THE DRAWINGS

FIG. 1 shows an automobile that has released the visual signal that alerts others nearby the automobile that there are unsafe driving conditions or an accident in accordance with at least one exemplary embodiment of the present disclosure.

FIG. 2 shows an automobile that has released the visual signal that alerts others nearby the automobile that there are unsafe driving conditions or an accident in accordance with at least one exemplary embodiment of the present disclosure.

### DETAILED DESCRIPTION OF THE PREFERRED EMBODIMENTS

The present disclosure is directed to an apparatus and method for alerting others that are nearby to the automobile or to dangerous driving conditions or accidents. For purposes of this disclosure an automobile is anything that is capable of carrying passengers, human or otherwise, and moves from one location to another. In one exemplary embodiment of the present disclosure, one or more sensors for detecting dangerous driving conditions or an automobile accident are provided on a vehicle. Sensors for detecting dangerous driving conditions or accidents are well known in the art as is the appropriate area to place them. For example, U.S. Pat. Nos. 6,803,852, 5,548,996, 3,650,809, 4,107,355, 4,694,688, 4,718,396, 4,821,560, 4,876,116, 4,965,102, 5,056,360, 5,079,945, 5,117,681, 5,119,670, 5,154,954, 5,361,630, 5,383,350, 7,070,203, 6,871,874, 6,869,101, 6,840,539, 6,796,578, 6,793,243, 6,789,819, 6,572,139, 6,434,461, 6,431,591, 6,343,810, 6,266,593, 6,254,127, 5,975,568, 5,707,077, 5,441,300, 5,338,062, 5,297,976, 5,291,014, 5,165,717, 6,948,750, 6,828,904, 6,607,212, 5,941,336, 5,826,216, 5,594,413, 5,486,832, 5,458,368, 5,435,409, 5,338,062, 5,309,138, 5,307,896, 5,179,256, 5,056,365, 5,034,580, 4,928,101, 4,164,263 and Patent Application No. 20030214696 (hereinafter, individually and collectively, “disclosure regarding sensors and related apparatus”), all of which are incorporated herein by reference, each disclosure various features and types of sensors and their related apparatus that could be used in more than one embodiment of the present disclosure.

The disclosure regarding sensors and their related apparatus also discusses the appropriate placement of the sensors, which also would be known to one or ordinary skill in the art. Accordingly, one of ordinary skill in the art could choose one or more appropriate sensors, depending on the desired application and automobile used, to sense unsafe driving conditions or an accident in accordance with the various embodiments of the present invention.

Examples of unsafe driving conditions that the method and apparatus of the present disclosure could detect include, but are not limited to, wet or slippery roads, flat or damaged tires or wheel, engine or transmission problems, hydroplaning of the automobile or nearby automobiles, an accident or soon to be accident with a nearby object, including other automobiles, and damage from debris or other objects.

Once the one or more sensors detect an accident or unsafe driving condition, in at least one embodiment of the present invention, the one or more sensors send a signal to a computer or microprocessor that controls the one or more devices that release one or more signals from the automobile. In this way the one or more sensors communicate with the computer or microprocessor to indicate that the one or more sensors have been activated or triggered due to detection of a dangerous driving condition or accident. The computer or microprocessor can be a part of the sensor or it can be an independently component of the apparatus. In at least one embodiment of the present disclosure, the computer or microprocessor (examples of which are disclosed in the disclosure regarding sensors and other related apparatus) sends a signal to the device containing the signal or signals that causes the device or devices containing the signal or signals to release those signal or signals and thereby warn those nearby to dangerous driving conditions or an accident. The computer of microprocessor can be any device or component that processes information or data from the one or more sensors that detects unsafe driving conditions or an accident or the one or more devices that releases the signals alerting those nearby to potentially dangerous conditions.

The apparatus also includes one ore more devices for releasing one or mores signals from the automobile. The one or more devices can be as simple as a container houses the signals until it receives a signal from the sensor, computer or microprocessor that the signals should be released, thereby alerting others that are nearby to dangerous driving conditions or accidents. The device can release the one or more signals by any means known to one of ordinary skill in the art, including but not limited to using, loaded springs, pressurized gases, explosives, electric motors or actuators, gases that are pre-filled or recently filled in the one or more signals and upon release, causes them to rise. These and other methods of releasing a device so that others nearby can see it, including those techniques and devices used in airbag technology presently employed in automobiles (some of which are discussed in the disclosure regarding sensors and other related apparatus), are well known in the art.

The signals that are released by the device act to alert those that are nearby of the dangerous driving conditions or accidents. The signals can be anything that catches the attention of those nearby and allows them to adjust their actions (e.g., move out of the way or slow down) to avoid an accident or lessen the severity of any accident. The signals can be specific for specific dangerous conditions of accidents and can be designed to act differently depending on the severity of dangerous driving condition or accident. Examples of signals that could be used with the present disclosure include, but are not limited to, one or more balloons, synthetic signs, displays made from foam materials or styrofoam, signals made of metal, plastic, fabric, a composite material or some combination thereof, cardboard or paper signs, flashing or strobe lights, a reflective material, inflatable containers containing one or more warning designation made of lightweight and resilient material, a device that makes audible noises and any other signal known to a person of ordinary skill that would alert others to unsafe driving conditions or an accident.

In one aspect of the present invention the one or more signals can be color or sign coded based on the driving condition or type of accident being reported and can be reused after they have been released by the one or more devices. In yet another aspect of the present invention the one or more signals move to gain the attention of those nearby.

In yet another aspect of the present invention the one or more devices release one ore more signals from the roof portion of the automobile. In this embodiment of the present disclosure, the signals are released from the top of the roof of the automobile ensuring that they do not block the visibility of the driver of the automobile in any way.

In yet another aspect of the present invention the one or more signals are released only when the car has slowed to a speed where wind resistance will not effect the one or more signals or stopped.

In yet another aspect of the present invention the one or more signals are a visual signal that appears above the most elevated portion the automobile to allow others nearby that one or more unsafe driving conditions or accidents have occurred. The one or more signals can be placed at the same height as the highest or most elevated point on the automobile or it can be placed up to 14 feet above the highest or most elevated point on the automobile.

In yet another aspect of the present invention the one ore more signals that are released from the automobile after an occupant of the automobile activates or triggers a button or sensor in the automobile. This allows occupants to determine exactly when the one or more devices for releasing signals releases those signals and eliminated the need for the sensor to detect and trigger or activate due to a dangerous driving condition or accident. This also allows an occupant of the automobile to send an emergency or warning signal when he or she needs help (e.g., needs medical attention, car has malfunctioned, car has skidded off the road and one or more occupants are trapped) but a dangerous driving condition or accident has not occurred.

In yet another aspect of the present invention one or more of the various components of the apparatus described and explained in this disclosure that alerts others to dangerous driving conditions or accidents or an occupant in need of help, is sold in a kit and added to the automobile.

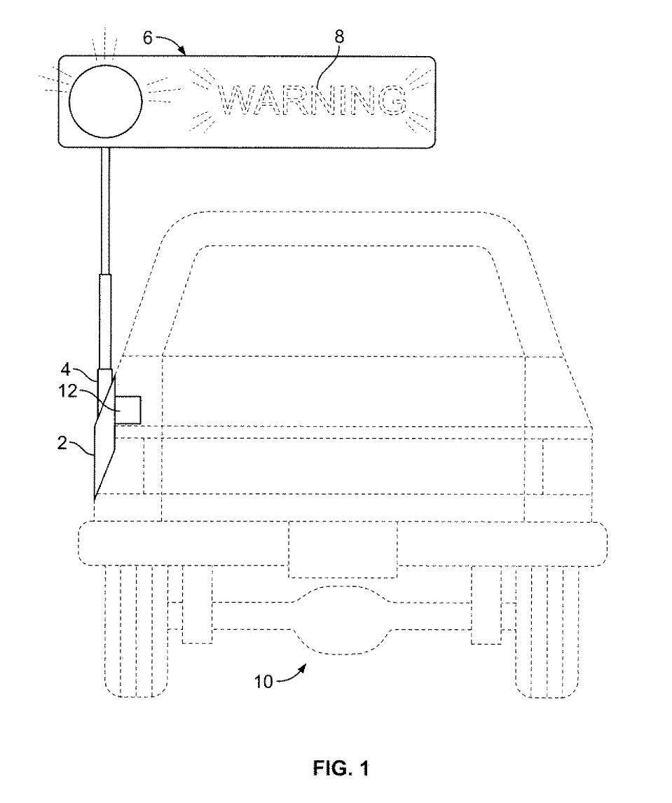

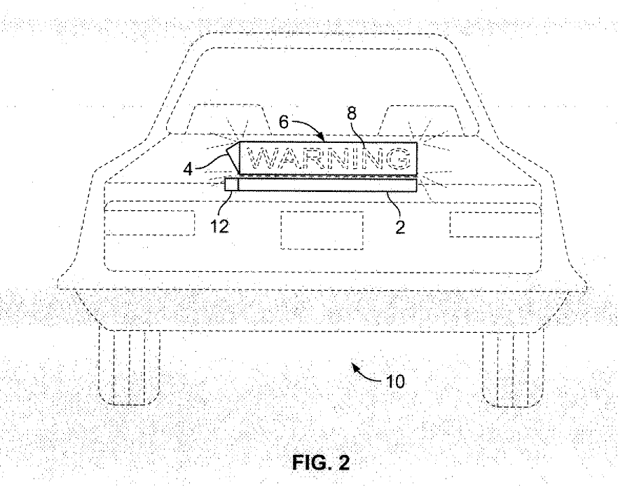

FIGS. 1 and 2 of the present disclosure depict two exemplary embodiment of the present invention wherein one or more sensors 12 are placed on an automobile 10 and communicate with one or more devices 2 for releasing one or more signals 6 from the automobile 10. In at least one embodiment of the present disclosure, the one or more devices 2 for releasing the one or more signals 6 causes a support member 4 to retract or be released from the device 2. The support member 4 acts to move the one or more signals 6 to a position where others nearby can see the one or more signals 6. The one or more signals 6, typically contain a message or warning 8, which alerts drivers to general or specific dangerous driving conditions or accidents or indicates the appropriate course of action in light of the circumstances (e.g., slow).

In yet another aspect of at least one embodiment of the present invention, the device 2 for releasing one or more signals 6 contains balloons pre-filled with helium or other buoyant gases that act as a signal to others nearby of an accident or unsafe driving conditions. Upon receiving a signal from the one or more sensors 12, the computer or microprocessor (which can be part of the one or more sensors 12 or a separate component now shown in the Figs.) sends a signal that an accident or unsafe driving condition has been detected. The device 2 opens or releases a compartment (which can be part of the device 2) housing the balloons causing the balloons, which act as signals 6, to be released from the device. The balloons 6 rise causing others nearby to appreciate that there are dangerous driving conditions or an accident. Those who see the balloons 6 can react appropriately, possibly slowing down and avoiding an accident or lessening the severity of any accident that the do encounter.

The foregoing detailed description of the present invention is provided for the purposes of illustration, and is not intended to be exhaustive or to limit the invention to the particular embodiments disclosed. The embodiments may provide different capabilities and benefits, depending on the configuration used to implement the key features of the invention. Accordingly, the scope of the present invention is defined only by the following claims.

What is claimed is:

1. An automobile apparatus for alerting other people that are nearby to the automobile to dangerous driving conditions or accidents comprising:
a. one or more sensors for detecting dangerous driving conditions or an automobile accident;
b. a computer or microprocessor that controls the one or more devices for releasing one or more signals from the automobile or the one or more sensors;
c. one ore more devices for releasing one or mores signals from the automobile that alert others that are nearby to one or more dangerous driving conditions or accidents; and
d. one ore more signals that are released from the automobile to alert others that are nearby to the automobile to one or more dangerous driving conditions or accidents;
wherein the one or more sensors communicate with the computer or microprocessor to indicate that the sensor has been activated or triggered;
wherein the computer or microprocessor communicates with the one or more devices for releasing one or more signals from the automobile to release one or more signals from the automobile; and
wherein the one or more devices for releasing one or more signals releases one or more signals from the automobile alerting others that are nearby to one or more dangerous driving conditions or accidents.

2. An apparatus of claim 1, wherein the one or more signal s that are released from the automobile to alert those that are nearby to one or more dangerous driving conditions or accidents have one ore more of the following characteristics:
a. are released by the device for releasing one or more signals by compressed air or minor explosives;
b. are comprised primarily of an aluminum;
c. are comprised primarily of a metal, a fabric, a plastic or a composite material;
d. are reflective to light;
e. include a flashing light or lights;
f. move back and forth relative to the automobile;
g. can be placed back into the device for releasing one or more signals from the automobile and re-used.
h. are spring loaded;
i. contain symbols or signs indicating one or more unsafe driving conditions or accidents; and
j. contain various color or symbols that indicate the level or type of hazardous road condition or accident.

3. An apparatus of claim 1, wherein the one or more devices for releasing one or more signals releases one ore more signals from the roof portion of the automobile.

4. An apparatus of claim 1, wherein the one or more signals are audio and visual signals that indicate to others that are nearby that they should slow down and be extra cautious because one or more dangerous driving conditions exist or accidents have occurred.

5. An apparatus of claim 4, wherein the one or more signals are a visual signal that appears at least one foot, and more preferably one to six feet, above the most elevated portion the automobile to allow others nearby that one or more unsafe driving conditions or accidents have occurred.

6. An apparatus of claim 1, wherein the one or more visual signals are provided at least four feet above the top or most elevated portion of the automobile.

7. An apparatus of claim 1, wherein the one ore more signals that are released from the automobile after an occupant of the automobile activates or triggers a button or sensor in the automobile.

8. A kit for use with a motor vehicle that alerts other people that are nearby to the motor vehicle to dangerous driving conditions or accidents, the kit comprising:
a. a device for releasing one or mores signals from the automobile that alert others that are nearby to one or more dangerous driving conditions or accidents; and
b. one ore more signals that are released from the automobile to alert others that are nearby to one or more dangerous driving conditions or accidents;
wherein the device for releasing one or more signals releases one or more signals from the automobile alerting others that are nearby to one or more dangerous driving conditions or accidents.

9. A kit of claim 8, wherein the one or more signals that are released from the automobile to alert those that are nearby to one or more dangerous driving conditions or accidents have one ore more of the following characteristics:
i. are released by the device for releasing one or more signals by compressed air or minor explosives;
ii. are comprised primarily of an aluminum;
iii. are comprised primarily of a metal, a fabric, a plastic or a composite material;
iv. are reflective to light;
v. include a flashing light or lights;
vi. move back and forth relative to the automobile;
vii. can be placed back into the device for releasing one or more signals from the automobile and reused.
viii. are spring loaded;
ix. contain symbols or signs indicating one or more unsafe driving conditions or accidents; and
x. contain various color or symbols that indicate the level or type of hazardous road condition or accident.

10. A kit of claim 8, wherein the kit further comprises:
c. one or more sensors for detecting dangerous driving conditions or an automobile accident;
d. a computer or microprocessor that controls the one or more sensors;
wherein the sensor communicates with the computer or microprocessor to indicate that the sensor has been activated or triggered; and
wherein the computer or microprocessor communicates with the device for releasing one or more signals from the automobile to release one or more signals from the automobile.

11. A kit of claim 8, wherein the one or more signals are audio and visual signals that indicate to others that are nearby that they should slow down and be extra cautious because one or more dangerous driving conditions exist or accidents have occurred.

12. A kid of claim 11, wherein the one or more signals are a visual signal that appears at least one foot, and more preferably one to six feet, above the most elevated portion the automobile to allow others nearby that one or more unsafe driving conditions or accidents have occurred.

13. A kit of claim 8, wherein the one or more visual signals are provided at least four feet above the top or most elevated portion of the automobile.

14. A kit of claim 8, wherein the one ore more signals that are released from the automobile after an occupant of the automobile activates or triggers a button or sensor in the automobile.

15. A method for preventing automobile accidents and reducing the severity of those automobile accidents that occur by alerting other people that are nearby to the automobile to dangerous driving conditions and accidents comprising:
a. providing a sensor on an automobile for detecting one or more dangerous driving conditions or accidents;
b. providing a device on the automobile that releases one ore more visual signals that alert others nearby when one or more dangerous driving conditions or accidents are detected by the sensor; and
c. providing a visual signal that alerts nearby drivers to one or more dangerous driving conditions;
wherein the sensor sends a signal to the device that releases one ore more visual signals from the automobile to release the one ore more visual signals when the sensor detects one or more dangerous driving conditions or accidents; and
wherein the released visual signal alerts others nearby to one or more dangerous driving conditions or accidents.

16. A method of claim 15, wherein providing a sensor on an automobile is performed by providing an automobile occupant that can sense or detect one or more unsafe driving conditions or automobile accidents.

17. A method of claim 16, wherein the automobile occupant activates or triggers a button that causes the device on the automobile that releases one or more visual signal to release the one or more visual signals which alerts other people nearby to one or more dangerous driving conditions or accidents.

18. A method of claim 15, wherein the one or more visual signals that are released from the automobile to alert those that are nearby to one or more dangerous driving conditions or accidents have one ore more of the following characteristics:
a. are released by the device for releasing one or more visual signals by compressed air or minor explosives;
b. are comprised primarily of an aluminum:
c. are comprised primarily of a metal, a fabric, a plastic or a composite material;
d. are reflective to light;
e. include a flashing light or lights;
f. move back and forth relative to the automobile;
g. can be placed back into the device for releasing one or more signals from the automobile and reused.
h. are spring loaded;
i. contain symbols or signs indicating one or more unsafe driving conditions or accidents; and
j. contain various color or symbols that indicate the level or type of hazardous road condition or accident.

19. A kit of claim 18, wherein the device for releasing one or more signals releases one ore more signals from the roof portion of the automobile.

20. A kit of claim 15, wherein the one or more signals are a visual signal that appears at least one foot, and more preferably one to six feet, above the most elevated portion the automobile to allow others nearby that one or more unsafe driving conditions or accidents have occurred.
